(19) United States
(12) Patent Application Publication
(10) Pub. No.: US 2018/0124880 A1
(43) Pub. Date: May 3, 2018

(54) Direct Current Power Server

(71) Applicant: LED Lighting IQ, LLC, North Olmsted, OH (US)

(72) Inventor: John T. Graven, North Olmsted, OH (US)

(73) Assignee: LED Lighting IQ LLC, North Olmsted, OH (US)

(21) Appl. No.: 15/647,845

(22) Filed: Jul. 12, 2017

Related U.S. Application Data
(60) Provisional application No. 62/362,445, filed on Jul. 14, 2016.

(51) Int. Cl. H05B 33/08; F21S 9/02; F21S 9/03; H02J 1/12; H02J 7/35; H02J 1/16

(52) U.S. Cl. CPC H05B 33/0803; F21S 9/026; F21S 9/028; F03D 9/255; H02J 1/12; H02J 7/35; H02J 1/16; F21S 9/03

(57) ABSTRACT

A distributed energy storage system is provided for a total integrated network environment. The system includes: a power server platform; and solid state low voltage lighting panels. The power server provides functions to LED panel lighting. The server works an intelligent gateway between the lighting and a variety of power sources, including conventional grid power. A modular server cabinet provides a grid tie point. Each server element provides a plurality of PCB mounted RJ45 connectors for electrical connection with low voltage panel lighting through network patch cables. The cables terminate between the power server rack and a low voltage panel light to provide 24 VDC power. The instant abstract is neither intended to define the invention disclosed in this specification nor intended to limit the scope of the invention in any way.

### RELATED APPLICATIONS

The present application claims the benefit of U.S. Provisional Application 62/362,445, filed on a 14 Jul. 2016 and incorporated by reference as if fully rewritten herein.

### BACKGROUND OF THE INVENTION

### 1. Field of the Invention

The present invention relates generally to the management and distribution of DC power and, more particularly, to a direct current power server for the storage and distribution of DC power throughout integrated networks.

### 2. Description of the Related Art

The recent increased interest in renewable energy has led to increased use of power generation sources such as wind turbine generators, photovoltaic cells (PV), fuel cells, batteries and the like. These technologies are sources that provide a relatively low voltage output of direct current. These DC sources are generally connected in serial or parallel circuits to obtain a sufficiently high voltage, which is then inverted to AC prior to being distributed onto the power grid.

Concurrently, similar conservation motives have let to the replacement of incandescent and fluorescent lighting with solid state, LED based lighting sources. Lighting is generally a majority use of electricity in residential and commercial settings. These solid state devices use low, DC current (normally lower than 3V), so that many of them need to be connected serially to achieve the required operating voltage. Further still, an AC power converted is required somewhere in the system when powered from the 110 VAC power grid.

With the ever expanding application of low voltage DC power sources, concurrent with the ever expanding application of low voltage DC power loads, a need exists and ever increasing need will exist for the management and distribution of DC power in conjunction with microgrids throughout commercial buildings (and eventually residential buildings) to provide local and distributed utilization of such assets, as well as to interface with the larger AC power grid.

Consequently, a need exists for an apparatus for and method of managing and distributing DC power throughout micogrids and integrated networks.

### SUMMARY OF THE INVENTION

It is therefor an object of the present invention to provide a direct current power server.

It is a feature of the present invention to provide a system of and method for the distribution of DC power that can be used to integrate DC power source with DC power loads, and especially DC low voltage lighting networks.

It is a further feature of the present invention to provide a system of and method for regulating power between such an integrated network and a larger utility electric grid.

Briefly described according to the preferred embodiment of the present invention a distributed energy storage system is provided for a total integrated network environment. The key functional elements of the system includes two main elements: a power server platform; and solid state low voltage lighting panels. The power server is provides functionality to a family of LED panel lighting. The server works as an intelligent gateway between the lighting and any of a variety of power sources, including renewable (wind, solar, biomass, etc.) or conventional grid power. A modular server cabinet provides a grid tie point and provides for modular, scalable housing of power server elements. Power server elements are standardized rack mounted housings that each provide a modular platform for containing a number of mobile battery modules. Each mobile battery module includes a plurality of cooperatively engaged lithium ion battery cells, and each mobile battery module within each server element is cooperatively engaged to one another in parallel electrical communication. Each server element provides a standardized size, rack mounted housing of a proprietary configuration in which a first end panel provides a plurality of PCB mounted RJ45 connectors for electrical connection with low voltage panel lighting through standard, low voltage Category 5e or Category 6 network patch cables. The Cat 5/6 network cables terminate between the power server rack and a low voltage panel light to provide 24 VDC power thereto. The server element provides a gateway between low voltage power sources and low voltage power loads, and can control, monitor and/or meter utility power being drawn from the power grid. Further, a utility grade inverter within the server cabinet can alternately control, monitor or meter power being placed back onto the power grid during times of excess local generation from the various renewable point sources.

A distributed energy storage system of the present invention provides a grid tie point and bidirectional interface for a total integrated network environment.

It is an advantage of the present invention is that it facilitates the integration of solid state lighting in residential and commercial settings.

It is another advantage of the present invention to provide an efficient integration of power to solid state lighting loads.

It is yet another advantage of the present invention to facilitate the conversion of residential and commercial lighting systems to DC power lighting systems that do not directly interface with the public utility power grid.

It is still another advantage of the present invention to allow for management and integration of renewable power generations sources within a microgrid.

It is still yet another advantage of the present invention to allow for the independent utilization and control of local DC microgrid sources and loads.

It is still another advantage of the present invention to allow for the integration and management of power generation from a variety of sources that may have different output characteristics.

It is still another advantage of the present invention to allow for a controlled interface between a power microgrid and a public utility power grid.

Further, the present invention provide for the efficient integration and utilization of power at a residential or commercial microgrid level in manner that is cost efficient, easy to install, and can be implemented in existing facilities easily and without excessive renovation.

Further objects, benefits, features and advantages will become apparent in light of the disclosures and teachings set forth herein below.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a direct current power management and control system according to the preferred embodiment of the present invention;

FIG. 2 is a partial close up front view showing interior configuration thereof;

FIG. 3 is a front perspective view of a power server element for use therewith;

FIG. 4 is a rear perspective view of the power server element of FIG. 3;

FIG. 5 is an inside perspective view of FIG. 4;

FIG. 6 is an exploded perspective view of the power server element of FIG. 3-5;

FIG. 7 is a perspective view of an electrical storage device for use with the power server element of the present invention;

FIG. 8 is an exploded perspective view of a solid state lighting panel for use with the present invention;

FIG. 9 is a graphical user interface of (a control software); and

FIG. 10 is a perspective view of a typical lighting configurations for use with the current invention.

### DESCRIPTION OF THE PREFERRED EMBODIMENTS

The following detailed description is of the best currently contemplated modes of carrying out exemplary embodiments of the invention.

The description is not to be taken in a limiting sense, but is made merely for the purpose of illustrating the general principles of the invention, since the scope of the invention is best defined by the appended claims.

The best mode for carrying out the invention is presented in terms of its preferred embodiment, herein depicted within the Figures.

### 1. Detailed Description of the Figures

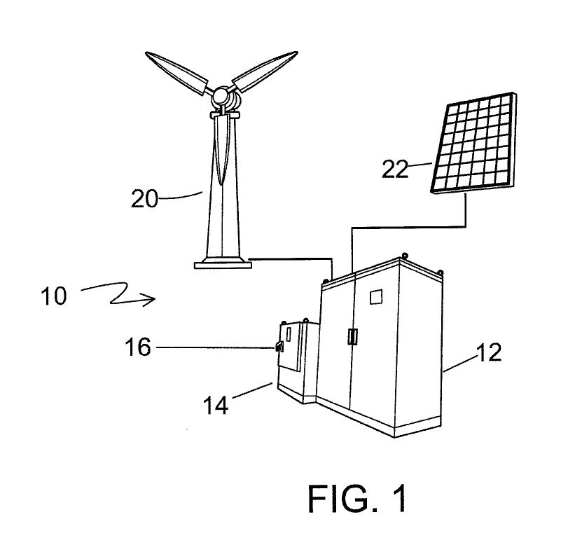

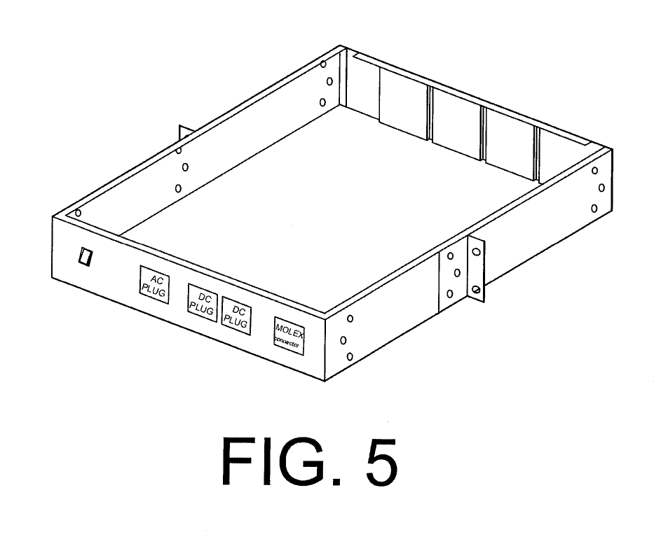

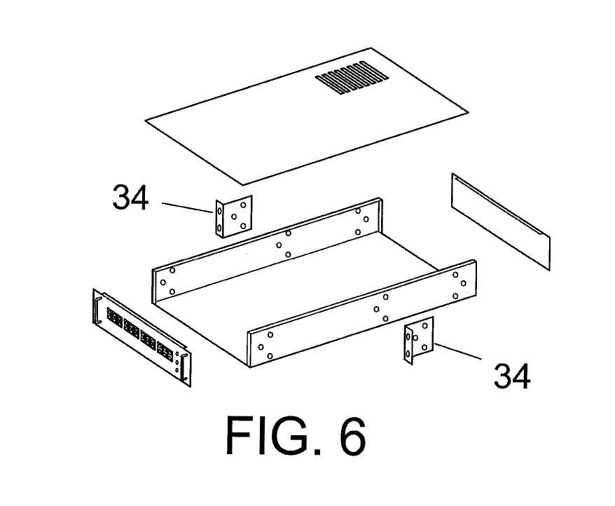

Referring now to FIG. 1 through FIG. 6, a direct current power management and control system is shown, generally noted as 10, according to the preferred embodiment of the present invention. The system 10 includes a server cabinet 12 in electrical communication with a utility grade power inverter 14.

The cabinet 12 may be of a modular design and, as would be apparent to one having ordinary skill in the relevant art, may be appropriately designed according to the standards and criteria of the National Electrical Manufacturers Association (NEMA) for safety, reliability and capacity growth.

The power inverter 14 provides an interface to the 120 VAC utility electrical grid 16. As will be better described in greater detail below, the inverter 14 converts incoming AC power for conversion to DC within electrical storage devices 70 during periods of utility net usage, and alternately may also provide outgoing AC power to be converted from excess DC power generation from various renewable sources integrated within the system 10. Renewable power generation sources may include wind turbine generator 20 or photovoltaic cells (PV) 22, but may further include any other type of distributed, local power generation unit, such as fuel cells, batteries and the like.

It should be understood that the present configuration is provided as exemplary, and that various modifications, combinations and permutations may be understood as being within the broad range of equivalents of the current invention. Generally, the cabinet 12 or plurality of such cabinets 12 function as distributed energy storage nodes within a total integrated network environment. The system 10 generally regulates power between such an integrated network and a larger utility electric grid 16.

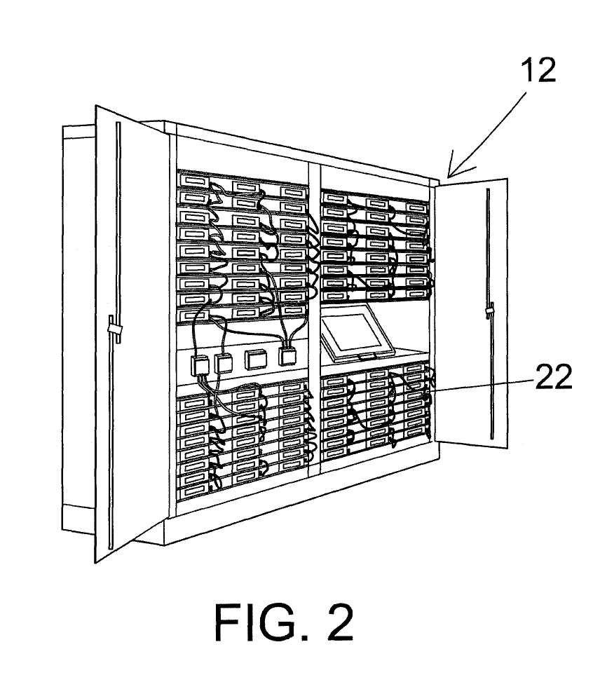

As best shown in conjunction with FIG. 2, within each cabinet 12 forms a power server support rack 22 that modularly house a plurality of power server elements 30. The power server 30 provides functionality to a family of LED panel lighting (described in greater detail below). The servers 30 work as an intelligent gateway between any low voltage lighting and any of a variety of power sources, including renewable (wind, solar, biomass, etc.) or conventional grid power.

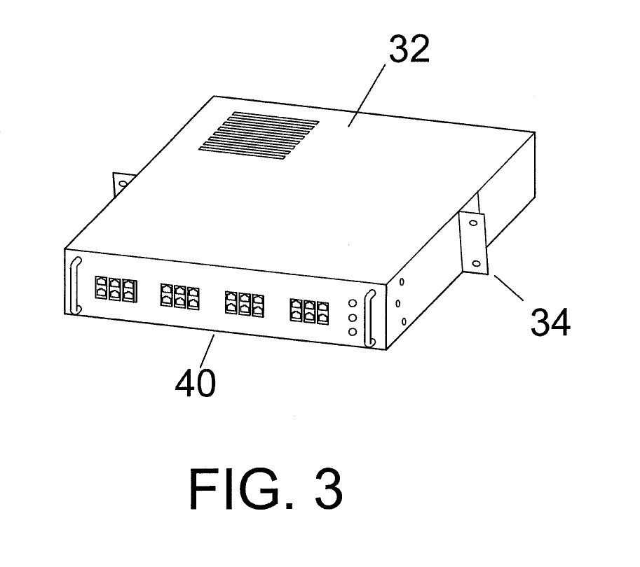

The modular server cabinet 12 provides a grid tie point and provides modular, scalable housing of power server elements 30. As best shown in conjunction with FIG. 3 through FIG. 6, the power server element 30 are standardized housings 32 having rack mounting attachments 34 and provide a modular platform for containing a number of mobile battery modules 70.

Each server element 30 provides a standardized size, rack mounted housing of a proprietary configuration in which a front end panel 40 provides a plurality of PCB mounted RJ45 connectors. As shown in a preferred configuration, an array of 24 connectors 42 are provided. While any particular configuration may otherwise be considered merely a design choice, in the preferred embodiment a standardized configuration is desirable and beneficial, and an array of connectors 42, shown herein in a quantity of 24 separated into two zones. The use of multiple zones is preferred. In this manner, power connections for those powered loads that are intermittent 42a may be separated from power connection for those power loads that are continuous 42b. Especially in commercial lighting scenarios, some lighting loads are desired or required to be always-on, such as, for example, emergency egress lighting. In contrast, task and area light in most scenarios are cycled throughout the day, and especially based upon building occupancy.

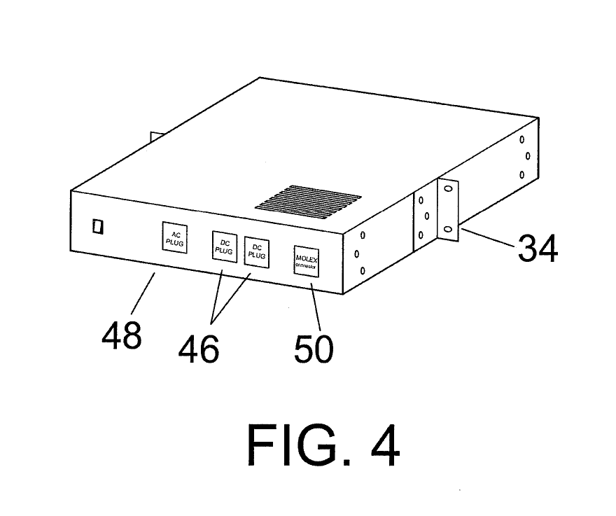

As show in conjunction with FIG. 4, a rear panel 44 provides power input connectors, including DC power inputs 46 and AC power inputs 48. An inter-server connection 50 may be provided for electrically connection any series of adjacent power servers 30. A server power disconnect 52 may further be provided to isolate any individual server element 30 from the power microgrid being formed by the system 10.

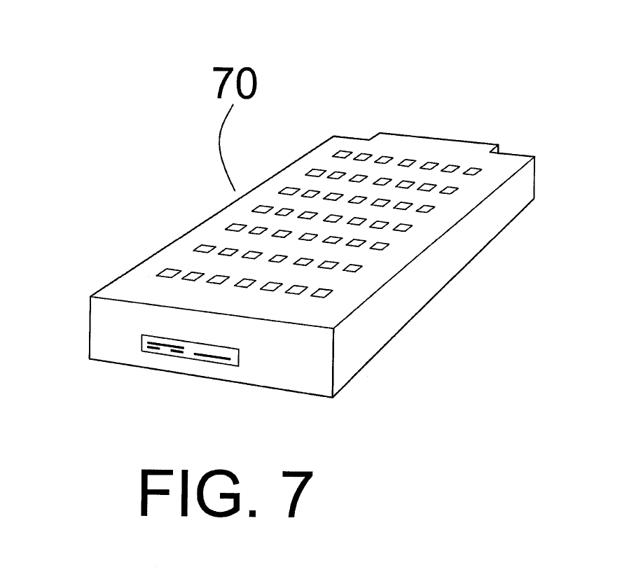

As best shown in conjunction with FIG. 7, each server element 30 houses a plurality of electrically interconnected electrical storage devices 70. It should be noted that one key intended feature of the present invention is the provision for a standard accumulation, control and distribution point between power sources (grid and/or renewal power sources) and the low voltage load used for facility lighting. As such, it is anticipated that the electrical storage devices 70 within the power server elements 30 may improve or change over time as improvements and innovations in such technologies exist. However, at present the preferred embodiment may include the use of mobile battery modules 70 of a type described or anticipated by or derived from the “Mobile Battery Modules for High Power Applications” as taught by and described in U.S. Pat. No. 9,312,524 issued in the name of Traczek et al and assigned to R.W. Beckett Corporation and incorporated by reference as if fully rewritten herein. Once such commercially available large format lithium-ion battery module in conformance with the '524 reference includes a Model 8224S lithium-ion battery module as available from Beckett Energy Systems of North Ridgeville, Ohio (see www.beckettenergy.com). Such a battery module provides 24 Vdc, 1.1 kWh (42 Ah) energy density that is configurable for energy storage systems from 24 Vdc to 500 Vdc through series/parallel combinations.

Once configured, the racks of power servers 30 charge the power storage elements 70 inside each power server 30. This accumulate, store energy is intended for distribution in one of two ways: back onto the power grid (after appropriate conditioning, metering and other qualifications require by regulation); or onto the distributed microgrid for power of low voltage lighting.

Electrical connection with low voltage panel lighting is intended through standard, low voltage Category 5e or Category 6 network type cables. The Cat 5/6 network cables terminate between the power server rack and a low voltage panel light 80 to provide 24 VDC power thereto. These network cables, commonly referred to as “cat 5” or “cat 6”, use twisted pair cable for carrying, normally, communication signals. It is further anticipated that such cable may be utilized directly that include an RJ45 connector. This type of cable is used in structured cabling for computer networks such as Ethernet. The cable is normally also used to carry other signals such as telephony and video. This cable has 8 pins and 8 wires that are normally used for communication in pairs. Further, an RJ45 connector is an standard connector for network cables featuring eight pins to which the wire strands of the cable interface electronically. While these connectors and cables have a standard and particular arrangement, in order to accommodate distribution of 24 Vdc power at the required anticipated loads and according to one aspect of the present invention pin/wire numbers 1-4 are combined together, and pin/wire 5-8 are similarly combined together through a jumper arrangement separate and carry the positive and negative electrical power signals. Such jumpering may occur at or after the RJ45 connector block, or may be implemented through an adapter or dongle that functions to perform such electrical communication between the various wires/pins.

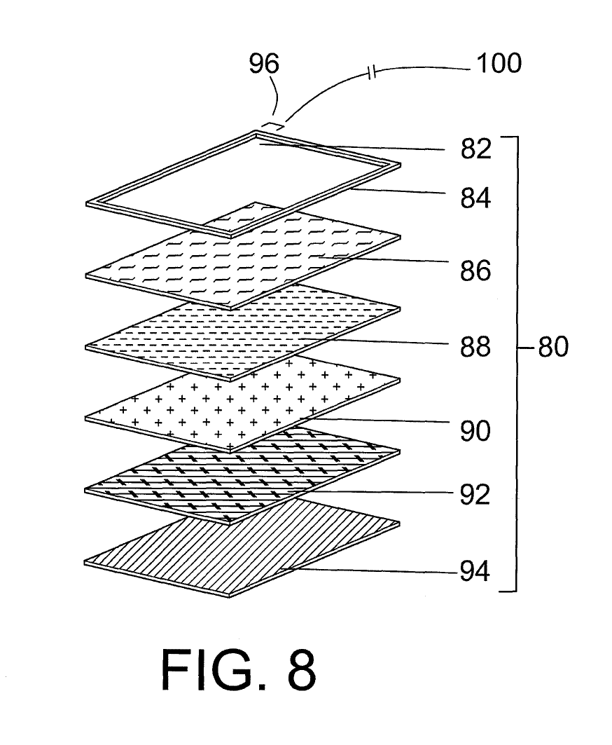

Referring now to FIG. 8, a typical panel light 80 is shown according to a preferred general configuration of a preferred embodiment of the present invention. It is anticipated that any number of configurations for solid state low voltage lighting panels may be used to implement the present invention. For purpose of enabling the preferred embodiment of the present invention at the time of this disclosure a typical panel light 80 provides PCB mounted LED lighting elements 82 is provided in an number of standard sized frames 84. One preferred configuration would be to provide standard sized square panels from between 6″×6″ to 2′ by 2′. Such a selection of sizes, while merely a design choice, may provide a significant pallet of lighting configurations for most commercial, and many residential applications. In any configuration, the lighting elements 82 are anticipated as including a plurality of light emitting diodes powered directly by low voltage direct current. By presenting the panels 80 directly with low voltage DC power, improved efficiencies can be achieved through prevention of power conversion losses. With such a configuration, one such embodiment shown may include: a diffuser plate 86; a light guide plate 88; a reflective element 90; a UV Foam Cotton 92; and a cover 94. Further, the panel 80 should be provided with an RJ45 connector 96 for terminal connection of the cable 100 for providing low voltage DC power from the system 10.

### 2. Operation of the Preferred Embodiment

In operation, the present invention provides a distributed energy storage system grid tie point and bidirectional interface for a total integrated network environment. The present invention facilitates the integration of solid state lighting in residential and commercial settings and provides an efficient integration of power to solid state lighting loads.

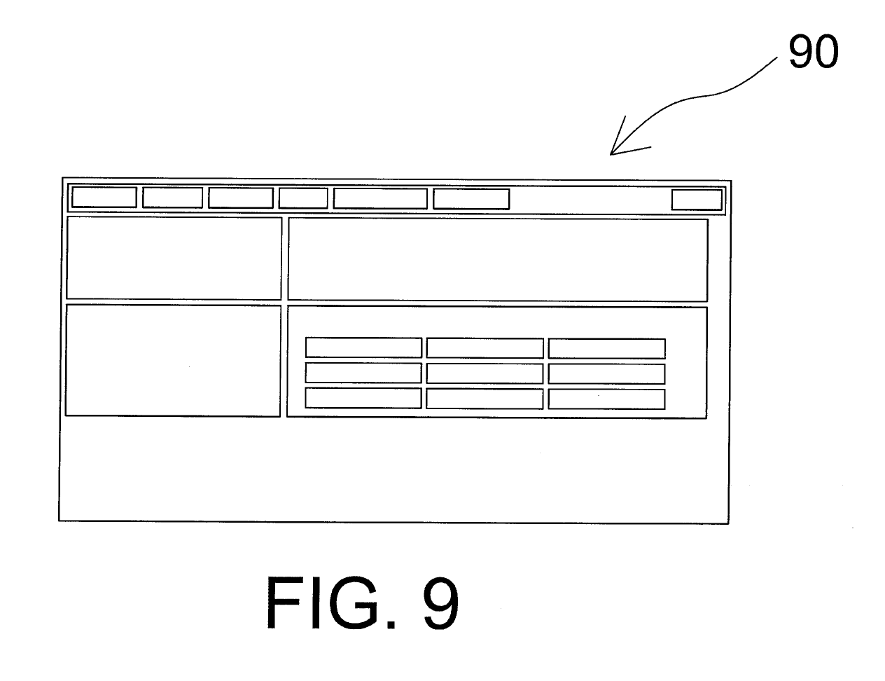

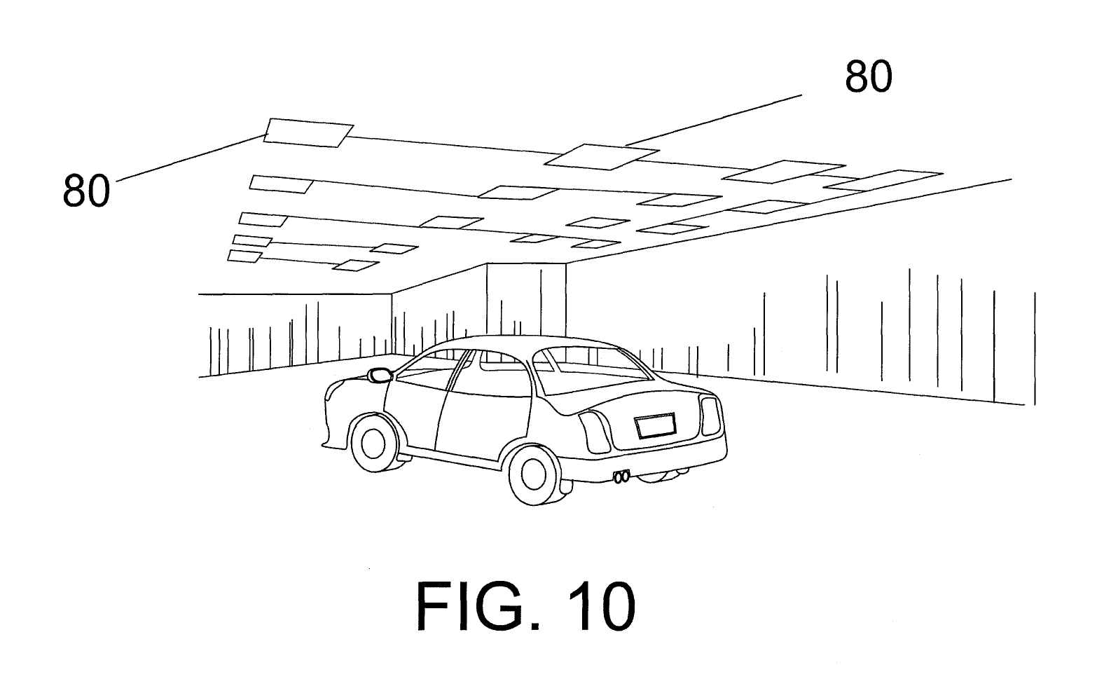

As shown in conjunction with FIG. 9-10, power is managed from various sources, including conventional AC grid power and secondary, non-grid DC power sources such as distributed, local renewable energy generation devices. Ultimately, lighting elements 80 are powered by 24 Vdc power controlled from server elements that provides a gateway between low voltage power sources, low voltage power loads, and metered utility power. The system 10 provides a control interface 90 for the control, monitoring and/or metering of utility power being drawn from the power grid, as well as secondary local power sources being generated from local generation of various renewable point sources.

Unless reasons exist to the contrary, judicial notice is taken of the facts that there is, in the relevant markets comprising, separately, renewable energy generation and low voltage, solid state lighting system that replace incandescent and/or fluorescent lighting systems. A long felt dominant trend exists that does separates the use of renewable energy production and LED lighting installation, rather than integrating the two trends to increase the efficiency and control of both. However, in spite of this, those skilled in the relevant art have not identified the integration of the two relevant markets with sufficient impetus to develop the present invention. Further, there is no identified motivation in the relevant market that provided sufficient impetus for the development of the present invention.

Unless reasons exist to the contrary, judicial notice is taken of the facts that common sense judgment requires that valid reasoning justifying such judgment be set forth. The teaching-suggestion-motivation test (“TSM” test), per KSR Int'l Co. v. Teleflex, Inc., 550 U.S. 398 (2007), can provide helpful insight into evaluating the obviousness of the invention. Given this insight in light of the above disclosed teachings, there is no reason not to use the TSM test in evaluating the obviousness of the invention described and claimed herein.

The foregoing descriptions of specific embodiments of the present invention are presented for purposes of illustration and description. They are not intended to be exhaustive nor to limit the invention to precise forms disclosed and, obviously, many modifications and variations are possible in light of the above teaching. The embodiments are chosen and described in order to best explain principles of the invention and its practical application, to thereby enable others skilled in the art to best utilize the invention and its various embodiments with various modifications as are suited to the particular use contemplated. It is intended that a scope of the invention be defined broadly by the Drawings and Specification appended hereto and to their equivalents, with the scope of the invention is limited only by the following claims.

Having thus described the invention what is claimed as new and desired to be secured by Letters Patent is as follows:

1. A direct current power server system comprising:
an enclosure;
at least one low voltage, direct current lighting element;
a direct current power server for controlling to said lighting elements a distribution of low voltage DC power from an array of energy storage devices;
an electrical grid connection configured to connect to an electrical grid and to receive alternating current power from the electrical grid;
a rectifier circuit disposed within the enclosure and connected between the electrical grid connection and the direct current power server, the rectifier circuit being configured to provide direct current power to the direct current energy storage devices by converting the alternating current power from the electrical grid connection to direct current power; and
a system controller configured to control power flow from the electrical grid and the energy source to the direct current power server.

2. The direct current power server of claim 1, further comprising:
a non-utility-grid energy source connection configured to connect to said energy storage devices and to receive direct current power from said energy source connection.

3. The direct current power server of claim 2, wherein said non-utility-grid energy source comprises a renewable energy source.

4. The direct current power server of claim 3, wherein said renewable energy source is selected from a group comprising: batteries; wind turbine generators; photovoltaic cells (PV); fuel cells; batteries; biomass or biofuels; geothermal; and tides and other hydro power generators.

5. The direct current power server of claim 1, further comprising:
an energy storage connection configured to connect to an energy storage device, to receive direct current power from the energy storage device, and to send direct current power to the energy storage device, the energy storage connection being connected to provide the direct current power from the energy storage device and to provide direct current power from the storage device, wherein the system controller is further configured to control power flow from the energy storage device.

6. The direct current power server of claim 2, further comprising:
an energy storage connection configured to connect to an energy storage device, to receive direct current power from the energy storage device, and to send direct current power to the energy storage device, the energy storage connection being connected to provide the direct current power from the energy storage device and to provide direct current power from the storage device, wherein the system controller is further configured to control power flow from the energy storage device.

7. The direct current power server of claim 3, further comprising:
an energy storage connection configured to connect to an energy storage device, to receive direct current power from the energy storage device, and to send direct current power to the energy storage device, the energy storage connection being connected to provide the direct current power from the energy storage device and to provide direct current power from the storage device, wherein the system controller is further configured to control power flow from the energy storage device.

8. The direct current power server of claim 4, further comprising:
an energy storage connection configured to connect to an energy storage device, to receive direct current power from the energy storage device, and to send direct current power to the energy storage device, the energy storage connection being connected to provide the direct current power from the energy storage device and to provide direct current power from the storage device, wherein the system controller is further configured to control power flow from the energy storage device.

9. The direct current power server of claim 5 further comprising:
power electronics disposed within an closure and connected between the energy storage connection and a direct current power load, the power electronics being configured to control charging and discharging of the energy storage device and being operated by the system controller.

10. The direct current power server of claim 9, wherein the direct current server is in electrical communication with direct current lighting of a building to provide direct current power to the direct current lighting.

11. The direct current power server of claim 10, wherein a system controller is configured to, in response to an outage on the electrical grid, operate the direct current power server to provide direct current power from the energy source connection to the direct current bus.

12. The direct current power server of claim 11, wherein the system controller is configured to, in response to no power being drawn by the direct current loads from the direct current bus, disconnect the energy source connection from the direct current bus.

13. A method of distributing and managing DC power comprising:
providing at least one DC load in electrical communication with a direct current power server;
providing at least one DC generation source in electrical communication with said direct current power server; and
said direct current power server comprises a plurality of power server elements that each containing a plurality of battery modules, wherein each battery module includes a plurality of cooperatively engaged battery cells, and each battery module within each server element is cooperatively engaged to one another in parallel electrical communication;
wherein said direct current power server is adapted to control distribution of DC current from said DC generation source to said at least one DC load.

14. The method of claim 13, wherein said at least one DC load includes at least one direct voltage powered lighting element.

15. The method of claim 13, wherein said at least one DC generation source is selected from a group comprising: batteries; wind turbine generators; photovoltaic cells (PV); fuel cells; batteries; biomass or biofuels; geothermal; and tides and other hydro power generators.

16. The method of claim 14, wherein said at least one DC generation source is selected from a group comprising: batteries; wind turbine generators; photovoltaic cells (PV); fuel cells; batteries; biomass or biofuels; geothermal; and tides and other hydro power generators.

17. The method of claim 13, further comprising:
providing an electrical communication connection from said direct current power server to an electrical utility power grid;
rectifying any excess energy generated by said at least one DC generation source that is not required by said at least one DC load; and
distributing rectified excess energy from said direct current power server to said electrical utility power grid.

18. The method of claim 13, wherein said direct current power server further comprises:
a plurality of power server elements that each containing a plurality of mobile battery modules, wherein each mobile battery module includes a plurality of cooperatively engaged battery cells, and each mobile battery module within each server element is cooperatively engaged to one another in parallel electrical communication.

19. The method of claim 13, wherein said parallel electrical communication is provided by a standard network cables, each having an RJ45 connector on at least one end having eight pins to which the wire strands of the cable interface electronically.

20. The method of claim 19, wherein:
pin/wire numbers 1-4 of said RJ45 connector are combined together through a first jumper arrangement; and
pin/wire 5-8 of said RJ45 connector are combined together through a second jumper arrangement;
said first jumper arrangement being electrically separate from said second jumper arrangement;
wherein said first jumper arrangement combines together pin/wire numbers for a positive electrical power signal and said second jumper arrangement combines together pin/wire numbers for a negative electrical power signal.
